(19) United States
(12) Patent Application Publication
(10) Pub. No.: US 2006/0130959 A1
(43) Pub. Date: Jun. 22, 2006

(54) Method and an apparatus for assembling tyres for vehicle wheels

(76) Inventor: Claudio Lacagnina, Busto Arsizio (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/530,487

(22) PCT Filed: Oct. 30, 2003
(86) PCT No.: PCT/IT03/00669

§ 371 Date: Oct. 19, 2005

(30) Foreign Application Priority Data
Nov. 5, 2002 (WO) PCT/IT02/00698

(51) Int. Cl. B29D 30/00

(52) U.S. Cl. 156/130; 156/117; 156/130.7; 156/396; 156/397

(57) ABSTRACT

A method of assembling tyres for vehicle wheels includes disposing a carcass structure on a primary drum, disposing a belt structure on an auxiliary drum, picking up the belt structure from the auxiliary drum to transfer the belt structure to a position coaxially centered with respect to the carcass structure, shaping the carcass structure, applying a tread band, and applying a pair of sidewalls. At least one of applying the tread band and pair of sidewalls is carried out by winding up at least one continuous strip element of elastomer material in contiguous circumferential coils around the carcass structure. An apparatus for assembling tyres for vehicle wheels includes at least one primary drum, the auxiliary drum, a transfer member, at least one unit for applying the tread band onto the belt structure, and at least one unit for applying the pair of sidewalls against lateral walls of the carcass structure.

The present invention relates to a method of assembling tyres for vehicle wheels. The invention also pertains to an apparatus for assembling vehicle tyres, to be used for putting into practice the above mentioned assembling method.

A tyre for vehicle wheels generally comprises a carcass structure including at least one carcass ply having respectively opposite end flaps turned up loop-wise around annular anchoring structures, each of said anchoring structures being usually made up of a substantially circumferential annular insert onto which at least one filling insert is applied, at a radially external position thereof.

Associated with the carcass structure is a belt structure comprising one or more belt layers, arranged in radial superposed relationship with each other and with the carcass ply and having textile or metallic reinforcing cords of crossed orientation and/or disposed substantially parallel to the circumferential extension direction of the tyre. Applied to the belt structure at a radially external position thereof is a tread band, made of elastomer material like other semifinished products being constituent parts of the tyre.

To the aims of the present description it is to be pointed out that by the term “elastomer material” it is meant a rubber blend in its entirety, i.e. the compound made up of at least one base polymer suitably amalgamated with reinforcing fillers and/or process additives of various types.

In addition respective sidewalls of elastomer material are also applied to the side surfaces of the carcass structure, each of them extending from one of the side edges of the tread band until close to the respective annular anchoring structure at the beads, which sidewalls, depending on the different embodiments, can exhibit respective radially external end edges either superposed on the side edges of the tread band so as to form a design scheme of the type usually referred to as “overlying sidewalls”, or interposed between the carcass structure and the side edges of the tread band itself, in accordance with a design scheme of the type referred to as “underlying sidewalls”.

In most of the known processes for tyre manufacture, the carcass structure and belt structure together with the respective tread band are provided to be made separately of each other in respective work stations, to be mutually assembled at a later time.

More particularly, manufacture of the carcass structure first contemplates deposition of the carcass ply or plies on a first drum usually identified as “building drum” to form a cylindrical sleeve. The annular anchoring structures at the beads are fitted or formed on the opposite end flaps of the carcass ply or plies that in turn are turned up around the annular structures themselves so as to enclose them in a sort of loop.

Simultaneously, on a second drum or auxiliary drum, an outer sleeve is made which comprises the belt layers laid down in radially superposed relationship with each other, and the tread band applied to the belt layers at a radially external position thereof. The outer sleeve is then picked up from the auxiliary drum to be coupled with the carcass sleeve. For the purpose, the outer sleeve is disposed in coaxial relation around the carcass sleeve, afterwards the carcass ply or plies are shaped into a toroidal conformation by axially moving the beads close to each other and simultaneously admitting fluid under pressure into the carcass sleeve, so as to determine application of the belt band and the tread band to the carcass structure of the tyre at a radially external position thereof. Assembling of the carcass sleeve with the outer sleeve can be carried out on the same drum as used for building the carcass sleeve, in which case reference is made to a “unistage building process”. A building process of this type is described in document U.S. Pat. No. 3,990,931, for example.

Alternatively, assembling may be carried out on a so-called “shaping drum” onto which the carcass sleeve and outer sleeve are transferred, to build the tyre following a so-called “two-stage building process”, as described in document EP 0 613 757, for example.

In conventional assembling methods the tread band is usually obtained from a continuously-extruded section member that, after being cooled for stabilisation of its geometrical conformation, is stored on suitable benches or reels. The semifinished product in the form of sections or of a continuous strip is then sent to a feeding unit carrying out either picking up of the sections or cutting of the continuous strip into sections of given length, each of them constituting the tread band to be circumferentially applied to the belt structure of a tyre being processed.

Known from document GB 1,048,241 is a machine for laying down a layer of elastomer material of varying thickness on a tyre carcass and comprising a feeding head to apply a ribbon of elastomer material to the carcass, means for setting the carcass in rotation around its axis for winding of a plurality of coils thereon when the carcass rotates with respect to the feeding head, means for moving the feeding head transversely of the carcass, from one side to the other of the circumferential median plane of the carcass, and means for automatically varying the transverse-movement amount for each winding revolution so as to vary the overlapping degree of the contiguous coils and consequently thickness of the layer formed on the carcass. In an appropriate version for making new tyres, during formation of the tread band the carcass is mounted on a building drum and has a cylindrical right conformation.

In document WO 01/36185, in the name of the same Applicant, a robotized arm bears a toroidal support on which each of the components of a tyre under production is directly made. The robotized arm gives the toroidal support a circumferential-distribution motion around its geometric axis, simultaneously with controlled transverse-distribution displacements in front of a delivery member supplying a narrow strip of elastomer material. The narrow strip therefore forms a plurality of coils the orientation and mutual-overlapping parameters of which are suitably managed so as to control the variations in thickness to be given to a component of a tyre being made, based on a predetermined deposition scheme preset on an electronic computer.

In the production contexts to which the present invention (contemplating production and storage of semifinished products and subsequent assembling of same on a building and/or shaping drum) is addressed, for manufacturing the tread bands and sidewalls, installation of extrusion lines is presently required that must necessarily have a high productivity, in order to offer appropriate responses in terms of economy on a large scale. As a result, an extrusion line is usually capable of supplying a plurality of assembling stations. In fact, productivity of the extrusion line is required to be adjusted in proportion to the productivity of the assembling stations the number of which has an influence on saturation and therefore productivity of the extrusion line.

In accordance with the present invention, the Applicant intends to overcome the strong constraints imposed by the above described circumstance, that particularly reveal themselves in the impossibility of the production plants being modified in response to sudden variations in the market demand in terms of productivity and product typology. In particular, since the plant productivity is greatly connected with the productivity of the tread band extrusion line, an increase in productivity would normally require installation of further tread band and/or sidewall extrusion lines, which would bring about an increase in the production capacity that at this point would be in excess with respect to the real market demand.

In addition, the Applicant has become aware of the fact that traditional methods tend to introduce structural unevennesses into the obtained tyres. In particular, it was found that a geometric evenness of the tread band and sidewalls is conditioned by a correct distribution of the strips of elastomer material applied to the carcass structure and/or belt structure, particularly at the end-to-end junctions of the extremities of each strip. A specifically critical aspect to the aims of the sidewall formation appears to be the important stretching in a circumferential direction to which the strips of elastomer material applied in accordance with the known art are necessarily submitted when the carcass structure is shaped into a toroidal conformation, starting from a substantially cylindrical conformation.

The Applicant has also become aware of the fact that, within the traditional methods of assembling tyres, the impossibility of indifferently putting into practice design schemes of the “overlying sidewall” type and of the “underlying sidewall” type without use of specific machinery being required for each design scheme, is essentially attributable to the adopted procedure in making the tread band and sidewalls.

The Applicant could further experience that also of difficult accomplishment is carrying out integration into the assembling plants, of equipment necessary to associate auxiliary reinforcing inserts with the carcass structure where required, in order to make tyres of the self-supporting type. Still in accordance with the present invention, the Applicant has understood that these limitations too can be surprisingly overcome by introducing into the assembling processes a different procedure for making the sidewalls and/or the tread band.

In accordance with the present invention, in dealing with the above discussed problems, the Applicant has considered the possibility of achieving great improvements in terms of production flexibility and quality of the product by manufacturing the tread band and/or sidewalls in the present tyre building processes contemplating assembling of semifinished products, through winding up of a continuous strip-like element into coils disposed in side by side relationship directly on the belt structure.

In more detail, it is an object of the present invention to provide a method of assembling tyres for vehicle wheels comprising the steps of: disposing on a primary drum, a carcass structure comprising at least one carcass ply in engagement with annular anchoring structures axially spaced apart from each other; disposing a belt structure comprising at least one belt layer, on an auxiliary drum; picking up the belt structure from the auxiliary drum to transfer it to a position coaxially centred with respect to the carcass structure; shaping the carcass structure according to a toroidal configuration for engagement of the belt structure with the carcass structure; applying a tread band to the belt structure in engagement with the carcass structure; applying a pair of sidewalls to the carcass structure on opposite sides thereof; wherein at least one of said steps of applying a tread band and applying a pair of sidewalls is carried out by winding up at least one continuous strip-like element of elastomer material in contiguous circumferential coils around a geometric axis of the carcass structure.

In accordance with a further inventive aspect, the above mentioned method can be carried out by means of an apparatus for assembling tyres for vehicle wheels comprising: at least one primary drum arranged to support a carcass structure comprising at least one carcass ply in engagement with anchoring structures axially spaced apart from each other; an auxiliary drum set to carry a belt structure; a transfer member to move the belt structure from the auxiliary drum to the carcass structure; a unit for application of a tread band to the belt structure; a unit for application of a pair of sidewalls against the opposite lateral walls of the carcass structure;

wherein at least one of said tread band and sidewall application unit comprises at least one delivery member to lay down at least one continuous strip-like element of elastomer material in contiguous circumferential coils around a geometric axis of the carcass structure.

Further features and advantages will become more apparent from the detailed description of a preferred, but not exclusive, embodiment of a method and an apparatus for assembling tyres for vehicle wheels, in accordance with the present invention.

This description will be set out hereinafter with reference to the accompanying drawings, given by way of non-limiting example, in which:

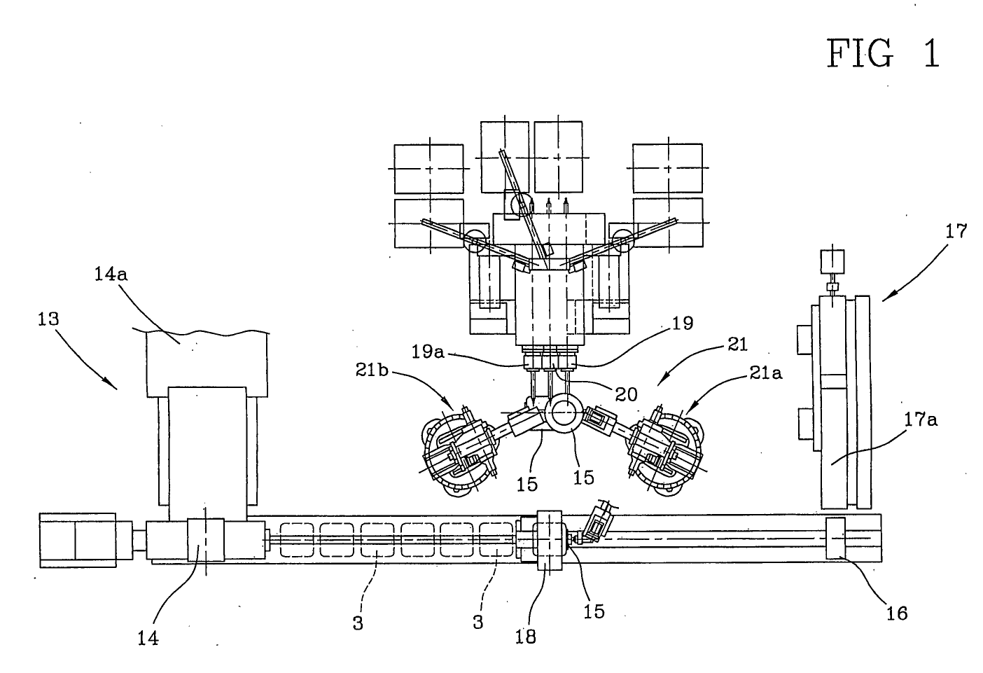

FIG. 1 is a diagrammatic top view of an apparatus for assembling tyres in accordance with the present invention;

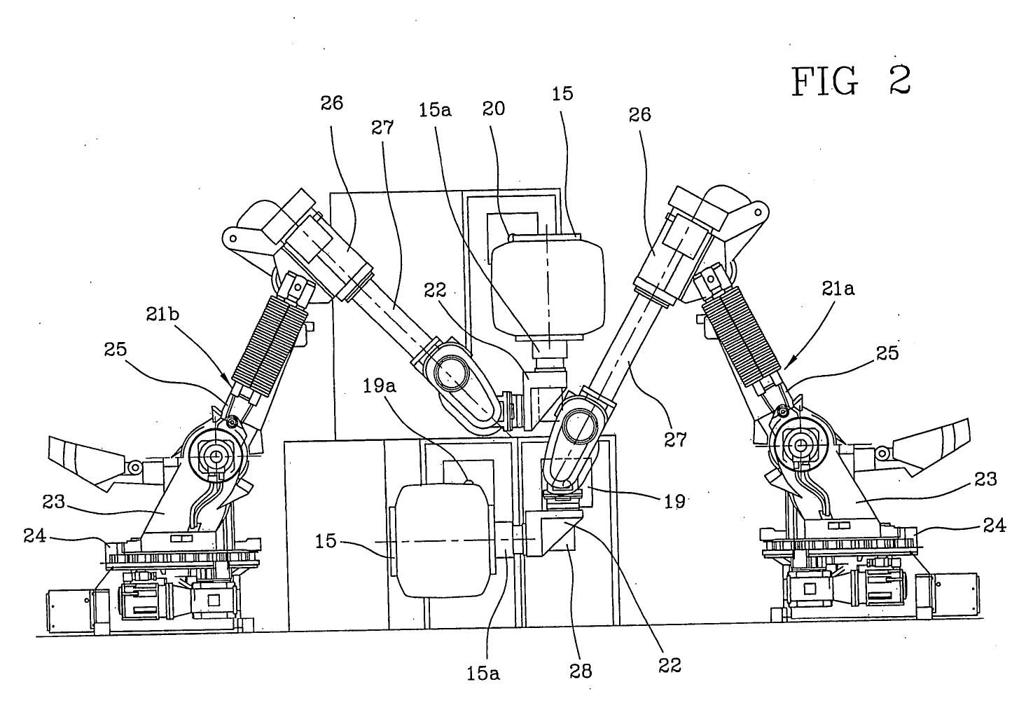

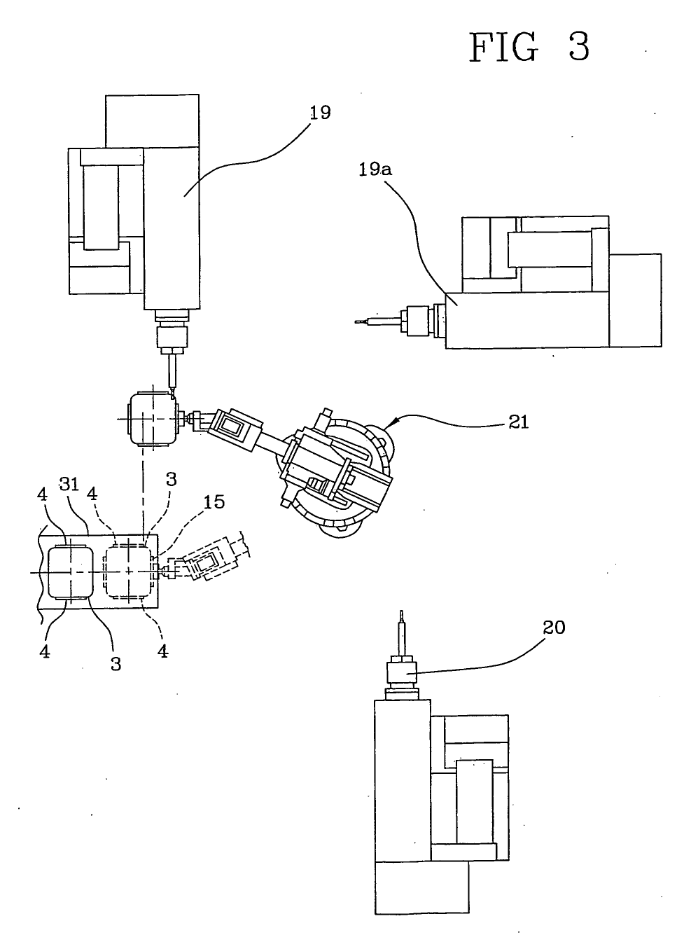

FIG. 2 is an elevation view of a portion of the apparatus in FIG. 1;

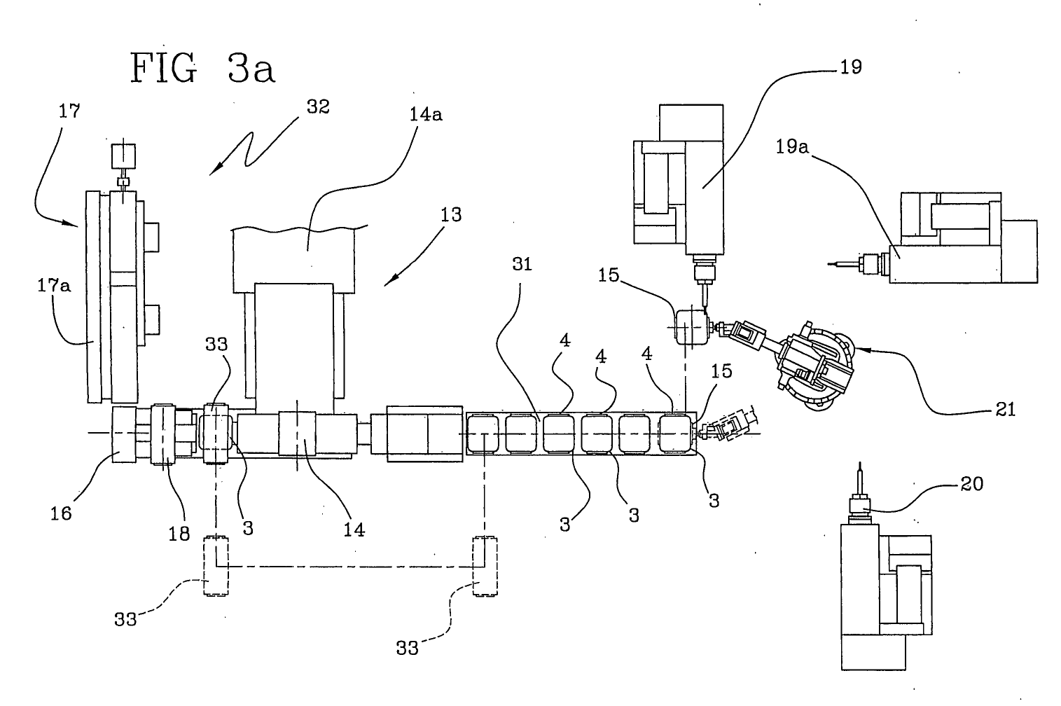

FIG. 3 is a diagrammatic top view of an apparatus for assembling tyres in accordance with a possible alternative embodiment of the present invention;

FIG. 3a is a diagrammatic top view of an apparatus for assembling tyres in accordance with a further alternative embodiment of the present invention;

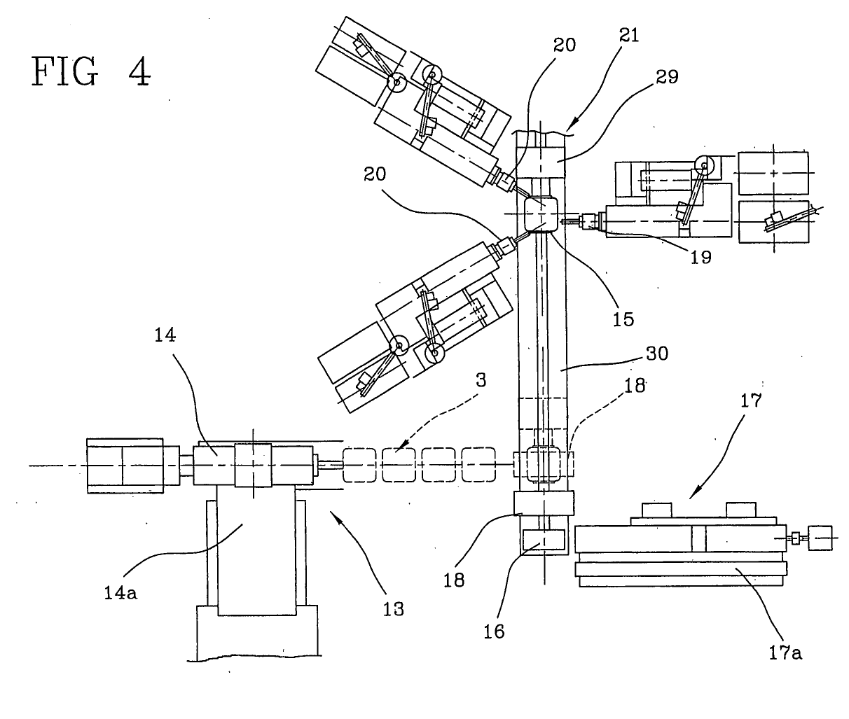

FIG. 4 is a diagrammatic plan view of a further alternative embodiment of a plant in accordance with the present invention;

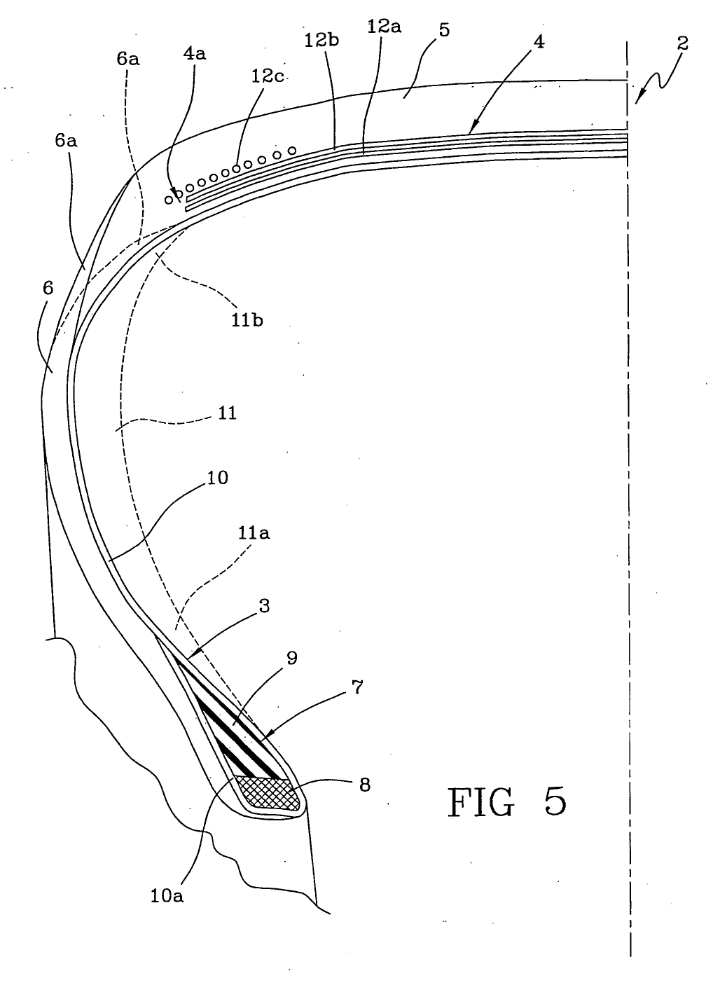

FIG. 5 is a diagrammatic fragmentary cross-section view of a tyre obtainable in accordance with the present invention.

Referring particularly to FIGS. 1 to 4, an apparatus for assembling tyres for vehicle wheels set to put into practice an assembling method in accordance with the present invention has been generally identified by reference numeral 1.

The invention aims at making tyres of the type generally identified with 2 in FIG. 5, essentially comprising a carcass structure 3 of substantially toroidal conformation, a belt structure 4 of substantially cylindrical conformation, circumferentially extending around the carcass structure 3, a tread band 5 applied to the belt structure 4 at a circumferentially external position thereof, and a pair of sidewalls 6 laterally applied, on opposite sides, to the carcass structure 3 and each extending from a side edge of the tread band until close to a radially internal edge of the carcass structure itself.

Each sidewall 6 may exhibit a radially external end tailpiece 6a at least partly covered with the extremity of the tread band 5, as shown in chain line in FIG. 5, following a design scheme of the type usually identified as “underlying sidewalls”. Alternatively, the radially external end tailpieces 6a of sidewalls 6 can be laterally superposed on the corresponding extremities of the tread band 5, as shown in solid line in FIG. 5, to achieve a design scheme of the type usually identified as “overlying sidewalls”.

The carcass structure 3 comprises a pair of annular anchoring structures 7 integrated into regions usually identified as “beads”, each of them being for example made up of a substantially circumferential annular insert 8 usually called “bead core” and carrying an elastomer filler 9 at a radially external position thereof.

Turned up around each of the annular anchoring structures are the end flaps 10a of one or more carcass plies 10 comprising textile or metallic cords extending transversely of the circumferential extension of tyre 2, possibly following a predetermined inclination between the two annular anchoring structures 7.

In self-supporting tyres or tyres intended for particular uses, auxiliary reinforcing inserts may be further provided, of the type usually called “lunettes” for example, applied close to the sidewalls 6 internally of the carcass ply 10 or between two paired carcass plies. As shown in chain line at 11 in FIG. 5, these auxiliary elastic-support inserts each have a radially internal edge 11a disposed close to one of the annular anchoring structures 7 and a radially external edge 11b disposed close to a side edge 4a of the belt structure 4.

The belt structure 4 can in turn comprise one or more belt layers 12a, 12b including metallic or textile cords suitably inclined to the circumferential extension of the tyre, in respectively crossed orientations between one belt layer and the other, as well as a possible external belting layer 12c including one or more cords circumferentially wound into coils axially disposed in side by side relationship around the belt layers 12a, 12b. The sidewalls 6 and tread band 5 each essentially comprise at least one layer of elastomer material of suitable thickness. Also associated with the thread band 5 may be a so-called substrate (not shown), of elastomer material having appropriate composition and physico-chemical features and acting as an interface between the true tread band and the underlying belt structure 4.

The individual components of the carcass structure 3 and belt structure 4, such as in particular the annular anchoring structures 7, carcass plies 10, belt layers 12a, 12b and further possible reinforcing elements designed to constitute the outer belting layer 12c, are supplied to apparatus 1 in the form of semifinished products made during preceding manufacturing steps, to be suitably assembled with each other.

Apparatus 1 is provided with devices for application of the carcass structure 3 on a primary drum 15. These application devices preferably comprise a building station 13 not described in detail as obtainable in any convenient manner and having a building drum 14 on which the carcass ply or plies 10 are first wound up; said plies come from a feeding line 14a along which they are cut into sections of appropriate length correlated with the circumferential extension of the building drum 14, before being applied thereto to form a so-called substantially cylindrical “carcass sleeve”.

Afterwards, the annular anchoring structures 7 are fitted onto the end flaps 10a of plies 10 to subsequently carry out turning-up of the end flaps themselves so as to cause engagement of the anchoring structures into the loops thus formed by the turned-up plies 10. If requested, the building station 13 may comprise devices for associating auxiliary reinforcing inserts with the carcass ply or plies 10, which inserts are applied during preliminary steps or steps alternated with the steps of laying down the ply or plies 10 and/or other components of the carcass structure 3. In particular, application of the above mentioned auxiliary reinforcing inserts or “lunettes” 11 may be provided directly on the building drum 14 before application of the carcass ply or plies 10, or on one of the carcass plies before application of an additional carcass ply 10.

When assembling of the components has been completed, transfer devices not shown pick up the carcass structure 3 from the building drum 14 to transfer it to the primary drum 15, of the type usually referred to as “shaping drum”, for example.

Alternatively, assembling of the carcass structure 3 components may take place directly on the primary drum 15.

Simultaneously with assembling of the carcass structure 3 on the building drum 14 or directly on the primary drum 15, manufacture of the belt structure on an auxiliary drum 16 takes place. More particularly, to this aim the auxiliary drum 16 is provided to interact with devices 17 for application of the belt structure 4, which devices may comprise at least one feeding line 17a for example, along which the semifinished products in the form of a continuous strip are caused to move forward, said strip being then cut into sections of a length corresponding to the circumferential extension of the auxiliary drum 16, concurrently with formation of the corresponding belt layers 12a, 12b thereon. A feeding unit for supplying one or more additional reinforcing inserts may be combined with the feeding line of the belt layers 17a, which additional inserts may consist of continuous cords for example (not shown in the drawings) to be applied onto the belt layers 12a, 12b in the form of axially contiguous circumferential coils, to form the outer belting layer 12c.

Upon the action of suitable transfer devices, the belt structure 4 disposed on the auxiliary drum 16 is adapted to be picked up therefrom and transferred onto the carcass structure disposed in the form of a cylindrical sleeve on the primary drum 15. The transfer devices may for example comprise a transfer member 18 of substantially annular conformation which is conveniently moved until it is positioned around the auxiliary drum 16 to pick up the belt structure 4 therefrom. In a manner known by itself, the auxiliary drum 16 disengages the belt structure 4 which is then handled by the transfer member 18 to be disposed on the primary drum 15 carrying the carcass structure 3, at a coaxially centred position. The primary drum 15 may also be set for interacting with the transfer member 18 following movement of the primary drum itself, starting from a position at which it lends itself to interact with the devices designed to engage the carcass structure 3 thereon.

The carcass structure 3 is then shaped into a toroidal conformation, by axial movement of the annular anchoring structures 7 close to each other and simultaneous admission of fluid under pressure to the inside of said carcass, until the carcass ply or plies 10 are brought into contact with the inner surface of the belt structure 4 retained by the transfer member 18. A rolling step to be made in any convenient manner, can be carried out on the belt structure 4 after the shaping step or concurrently therewith, to obtain better adhesion of the belt layers 12a, 12b, 12c against the carcass ply or plies 10.

Upon occurrence of said engagement, the primary drum 15 together with the carcass structure 3 and belt structure 4 engaged thereon are moved towards one or more units for application of the tread band 5 and/or the sidewalls 6, starting from a position at which the primary drum interacts with the transfer member 18.

In accordance with the present invention, at least one of the steps of applying the tread band 5 and sidewalls 6 is carried out by winding up at least one continuous strip-like element of elastomer material in contiguous circumferential coils around a geometric axis of the carcass structure 3.

Preferably, both application of the tread band 5 and application of the sidewalls 6 are carried out following the above procedure, as better described in the following. However the possibility of making the sidewalls 6 in another manner is not excluded, by means of a sidewall-feeding line (not shown) for example, which is associated with the building station 13 and arranged to feed at least one semifinished product in the form of a continuous strip of elastomer material, from which the sidewalls themselves are cut into sections of predetermined length, correlated with the circumferential extension of the primary drum 15 and the tyre 2 to be obtained. The tread band 5 can be in turn directly made against the belt structure 4 formed on the auxiliary drum 16, by a feeding line supplying a semifinished product in the form of a continuous strip for example, from which the tread bands are formed by cutting operations leading to formation of sections of appropriate length.

In a preferential embodiment, the devices for application of the tread band and/or the sidewalls comprise one or more delivery members 19, 19a, 20 each arranged to lay down a respective continuous strip-like element of elastomer material on the carcass structure 3 and/or belt structure 4. Each delivery member 19, 19a, 20 may for example comprise an extruder, an applicator roller or other member that, when placed close to the tyre being processed, lends itself to deliver the continuous strip-like element of elastomer material directly against the belt structure 4 and/or carcass structure 3 borne by the primary drum 15, simultaneously with winding up of the strip-like element itself around the geometric axis of the carcass structure 3.

More particularly, at least one first delivery member 19 is provided which is part of a unit for application of the tread band 5 to the belt structure 4. The first delivery member 19 can be set to deliver a first continuous strip-like element directly against the belt structure 4, to form the tread band 5.

When for manufacture of the tread band 5 formation of a so-called substrate is required, an auxiliary delivery member 19a can be provided to directly lay down an auxiliary strip-like element against the belt structure 4 before intervention of the fist delivery member 19, in order to form the above mentioned substrate of elastomer material.

Also provided is at least one second delivery member 20, being part of a unit for application of the sidewalls 6 to the carcass ply or plies 10. The second delivery member 20 is set to deliver a second continuous strip-like element directly against the carcass ply 10, simultaneously with winding up of the strip-like element itself on the belt structure 3 borne by the primary drum 15.

An actuating assembly 21 co-operates with the delivery members 19, 19a, 20 to define the above mentioned units for application of the tread band 5 and/or the sidewalls 6. The actuating assembly 21 in fact operates on the primary drum 15 to drive it in rotation around a geometric axis thereof, so that each of the strip-like elements is circumferentially distributed on the carcass structure 3. Simultaneously, the actuating assembly 21 carries out controlled relative displacements between the primary drum 15 and delivery member 19, 19a, 20 to distribute the strip-like element in coils disposed in mutual side by side relationship to form the tread band 5 and/or the sidewall 6 in accordance with the desired thickness and geometric-conformation requirements.

In a preferential embodiment shown in FIGS. 1 and 2, the actuating assembly 21 is integrated into at least one robotized arm 21a, 21b carrying an end head 22 to which the primary drum 15 is fastened in cantilevered fashion by a shank 15a coincident with the geometric axis thereof. In the example shown (see FIG. 2) the robotized arm 21a, 21b comprises a base 23 rotating on a fixed platform 24 around a first vertical axis, a first portion 25 oscillatably connected to base 23 around a second, preferably horizontal, axis, a second portion 26 oscillatably connected to the first portion 25 around a third axis, which is preferably horizontal too, and a third portion 27 rotatably supported by the second portion 26 around an axis orthogonal to the third oscillation axis. The head 22 of the robotized arm 21a, 21b is connected at its end with the third portion 27, being allowed to oscillate around a fifth and a sixth oscillation axes that are perpendicular to each other, and rotatably carries the primary drum 15, operable in rotation by a motor 28.

The robotized arm 21a, 21b therefore is adapted to support the primary drum 15 and to control movement of same during the whole production cycle, by conveniently positioning it for the purpose of enabling interaction of same with the devices for transfer of the carcass structure 3 from the building station 13 and, subsequently, with member 18 for transfer of the belt structure 4 and by driving it in rotation in front of the delivery members 19, 19a, 20 designed to form the tread band 5 and sidewalls 6.

In more detail the robotized arm 21a, 21b after positioning of the primary drum 15 so as to enable engagement of the carcass structure 3 thereon, brings the drum itself to a position in coaxial relationship with the transfer member 18 of the belt structure 4.

When engagement of the belt structure 4 on the carcass structure 3 has occurred, following shaping of the carcass structure 3 into a toroidal conformation, the robotized arm 21a, 21b takes the primary drum 15, while conveniently moving it, in front of the possible auxiliary delivery member 19a designed to make the substrate and subsequently in front of the first delivery member 19, upon the action of which formation of the tread band 5 is completed.

The primary drum 15 is then transferred to the second delivery member 20, and suitably moved in front of the latter to cause formation of one of the sidewalls 6 at a lateral position against the carcass structure 3, just as an indication starting from the annular anchoring structure 7, until close to the corresponding lateral edge of the previously-formed tread band 5. Following overturning of the primary drum 15 in front of the second delivery member 20, formation of the second sidewall 6 is started on the carcass structure 3 side opposite to the previously formed sidewall 6.

The above described operating sequence enables sidewalls 6 to be formed in such a manner that their radially external tailpieces 6a laterally overlap the side edges of the tread band 5 following a design scheme of the type usually called “overlying sidewalls”.

The invention however also enables accomplishment, in an easy manner too, of sidewalls 6 following a design scheme of the type usually called “underlying sidewalls”.

For the purpose, immediately after engagement of the belt structure 4 with the carcass structure 3, the primary drum 15 is transferred in front of the second delivery member 20 to cause formation of sidewalls 6 before being brought in front of the possible auxiliary delivery member 19a and the first delivery member 19 to form the tread band 5. The opposite side edges of the tread band 5 thus obtained will be superposed at the radially external tailpieces 6a of sidewalls 6.

During working, each of the delivery members 19, 19a, 20 preferably keeps a fixed positioning, while the primary drum 15 is driven in rotation and suitably moved in a transverse direction by the robotized arm 21a, 21b, so as to cause distribution of each continuous strip-like element in order to form a layer of appropriate shape and thickness upon the carcass structure 3 and/or the belt structure 4. The continuous strip-like element fed from each of the delivery members 19, 19a, 20 can advantageously have a flattened section so that it can modulate the thickness of the formed elastomer layer by varying the overlapping amount of the contiguous coils and/or orientation of the surface of the tyre being processed with respect to the cross-section outline of the strip-like element coming from the delivery member itself.

Once manufacture of the tread band 5 and sidewalls 6 has been completed, the robotized arm 21a, 21b causes a new translation of the primary drum 15 to move it away from the delivery members 19, 19a, 20 and position it in front of devices carrying out disengagement of the assembled tyre 2 from the primary drum 15.

In a preferential embodiment, apparatus 1 is set to simultaneously carry out manufacture of two tyres 2.

For the purpose, as shown in FIGS. 1 and 2, apparatus 1 is provided with a first and a second primary drums 15, supported by a first and a second actuating assemblies 21a, 21b respectively, to be sequentially led to interact with the devices for application of the carcass structure 3, the transfer member 18 of the belt structure 4, the unit for application of the tread band 5 and the unit for application of the sidewalls 6.

The steps of the tyre-assembling process are cyclically carried out on each of the primary drums 15 following a controlled rate. The step of disposing the carcass structure 3 on anyone of the primary drums 15 is carried out before tyre assembling on the other primary drum 15 has been completed. In this way there is no waiting period for the tyres being processed during the different process steps and therefore downtime is avoided and the risk that the same step should be carried out simultaneously on both tyres being processed is eliminated.

In the alternative embodiment shown in FIG. 3, the carcasses 3 coupled with the respective belts 4 are provided to be supplied to the units for application of the tread band and/or the sidewalls after storage in a magazine or on appropriate benches diagrammatically denoted by 31 in FIG. 3, to which each carcass structure 3, mounted or not on the respective primary drum 15, is transferred after engagement with the respective belt structure 4. The robotized arm 21 sequentially picks up each carcass structure 3 from the magazine or the storage benches to mount it (if required) on the primary drum 15 and submit it to the action of extruders 19, 19a, 20 intended for formation of the tread band 5 and/or sidewalls 6. In the embodiment shown a single robotized arm 21 is provided, but a pair of robotized arms can be arranged in case of need, in the same manner as described with reference to FIGS. 1 and 2.

The alternative embodiment shown in FIG. 3a allows the carcass structure 3/belt structure 4 assembly to be made together, through use of a conventional assembling machine 32 integrating the building station 13 and the devices 17 for application of the belt structure 4, so as to subsequently rely on extruders 19, 19a, 20 and on the actuating assembly 21 for accomplishment of the tread band 5 and/or the sidewalls 6 following the above described modalities.

In particular, the operating sequence of the assembling machine 32 provides for the belt structure 4 made on the auxiliary drum 16 to be picked up from said drum upon the action of the transfer member 18, to be disposed at a coaxially centred position on the carcass structure 3 previously formed on the building drum 14. Through mutual approaching of the annular anchoring structures 7 by means of the building drum 14, the carcass structure 3 is shaped into a toroidal configuration and consequently coupled with the belt structure 4. An auxiliary transfer member 33 or equivalent device picks up the carcass structure 3 coupled with the belt structure 4 from the building drum 14, to lay the manufactured article onto the bench or storage magazine 31.

The robotized arm 21 or an equivalent handling member carrying the primary drum 15 will then pick up the carcass structure 3 coupled with the belt structure 4 from the bench or storage magazine 31, to submit the manufactured article to the action of extruders 19, 19a, 20 for the purpose of making the tread band 5 and/or sidewalls 6.

As an alternative to the above description, the robotized arm 21 can pick up the manufactured article directly from the auxiliary transfer member 33. In addition, the functions herein performed by the auxiliary transfer member 33 can possibly be carried out manually by an operator.

In a possible further alternative embodiment shown in FIG. 4, the actuating assembly 21 comprises a carriage 29 movable along a guide structure 30, between a first position at which, as shown in chain line, it supports the primary drum 15 in front of the application devices for the carcass structure 3, at an appropriate location for receiving the latter from the transfer members associated with the devices themselves, and a second position at which, as shown in solid line, it supports the primary drum 15 at a location close to the delivery members 19, 20. In this case the presence of at least two extruders or other delivery members 20 designed to form the sidewalls may be provided, said members being optionally radially and/or transversely movable with respect to the geometric axis of the carcass structure 3 to cause distribution of the respective strip-like elements in the form of coils disposed in radial side by side relationship against the opposite sides of the carcass structure 3 being made.

In accordance with another alternative embodiment, that can be adopted in anyone of the above described embodiments, the actuating assembly 21 may be provided to carry out translation of the delivery member or members 19, 19a, 20 transversely of the circumferential extension of the carcass structure 3 and/or belt structure 4, to cause a transverse distribution of the coils formed of the continuous strip-like element.

The present invention achieves important advantages.

Manufacture of the tread band 5 and/or sidewalls 6 by winding a continuous strip-like element into coils disposed in side by side relationship enables in fact all the limits of the known art correlated with the requirement of using complicated and bulky machinery for producing the tread bands and sidewalls by extrusion to be overcome; in fact use of this complicated and bulky machinery involves high investment and running costs only justified by a production on a large scale. The invention on the contrary enables the tread band and sidewalls to be produced with much simpler and less bulky machinery, suitable for a production adjusted in proportion to the productivity of the individual assembling apparatus 1.

Consequently, tyre-building plants currently in use and comprising a plurality of assembling apparatus interlocked with the same extrusion line for the tread band and/or sidewalls, can be advantageously adapted to the increases in productivity requested by the market, by merely adding one or more apparatus according to the invention, so as to obtain an increase in productivity meeting the market requirements.

It should be also appreciated that the present invention enables a greater evenness of the tread band and sidewalls to be achieved, which evenness in the known art was greatly conditioned by a correct distribution of the strip of elastomer material being applied, particularly at the end-to-end junction of the extremities of the strip itself. With reference to sidewall formation, it is further to be pointed out that the invention allows elimination of the critical state generated by the considerable stretching in a circumferential direction to which the strips of elastomer material applied in accordance with the known art were inevitably submitted following the step of shaping the carcass structure, above all close to the radially external end tailpieces.

In the known art, these conditions also gave rise to a great number of discarded products, the present invention, on the contrary, allowing to eliminate them.

Furthermore, the invention allows the operating flexibility of the plants to be greatly increased so as to make it possible to produce tyres the sidewalls of which are indifferently disposed in accordance with either the design scheme “overlying sidewalls” or the design scheme “underlying sidewalls” depending on requirements, and also to enable integration of the auxiliary reinforcing inserts 11 for the purpose of manufacturing self-supporting tyres without any substantial modification to the plant being required to this aim.

In addition, further advantages from a qualitative point of view have repercussions on traditional extrusion lines when the apparatus in reference is used in combination with other apparatus interlocked with an extrusion line of known type. For example, combination of the concerned apparatus with a known plant provided with one or more traditional extrusion lines makes it possible to reduce productivity of the extrusion lines when it is necessary to carry out working of particular blends and materials that, due to process requirements, cannot be extruded at high speed, without on the other hand impairing the overall productivity of the plant. In addition, the extrusion lines can be advantageously utilised with an appropriate margin from their maximum productivity limit, under such conditions that more guarantees in terms of constancy in the quality of the obtained product are obtained.

1-33. (canceled)

34. A method of assembling tyres for vehicle wheels, comprising:
disposing a carcass structure on a primary drum;
disposing a belt structure on an auxiliary drum;
picking up the belt structure from the auxiliary drum to transfer the belt structure to a position coaxially centered with respect to the carcass structure;
shaping the carcass structure into a toroidal configuration;
applying a tread band onto the belt structure; and
applying a pair of sidewalls to the carcass structure on opposite sides of the carcass structure;
wherein the carcass structure comprises at least one carcass ply in engagement with annular anchoring structures axially spaced apart from each other,
wherein the belt structure comprises at least one belt layer, and
wherein at least one of applying the tread band and applying the pair of sidewalls is carried out by winding up at least one continuous strip element of elastomer material in contiguous circumferential coils around the carcass structure.

35. The method of claim 34, wherein applying the tread band is carried out by winding at least one first continuous strip element of elastomer material, in a form of contiguous circumferential coils, around the belt structure.

36. The method of claim 34, wherein applying each of the pair of sidewalls is carried out by winding at least one second continuous strip element of elastomer material in contiguous circumferential coils around the carcass structure.

37. The method of claim 34, wherein applying the pair of sidewalls is carried out after the carcass structure has been shaped into the toroidal configuration.

38. The method of claim 34, wherein applying the pair of sidewalls is carried out after applying the tread band.

39. The method of claim 34, wherein applying the pair of sidewalls is carried out before applying the tread band.

40. The method of claim 34, wherein the at least one strip element is fed from at least one delivery member disposed close to the tyre being assembled, simultaneously with winding up the at least one strip element around a geometric axis of the carcass structure.

41. The method of claim 40, wherein feeding the at least one strip element is carried out by extrusion through the at least one delivery member.

42. The method of claim 40, further comprising:
giving the primary drum a circumferential-distribution rotary motion around a geometric rotation axis of the primary drum, so that the at least one strip element is circumferentially distributed around the geometric axis of the carcass structure; and
carrying out controlled relative transverse-distribution displacements between the primary drum and the at least one delivery member, so that the at least one strip element forms a plurality of coils disposed in mutual side-by-side relationship;
wherein giving the primary drum the circumferential-distribution rotary motion and carrying out the controlled relative transverse-distribution displacements are carried out concurrently with winding up the at least one strip element.

43. The method of claim 42, wherein the controlled relative transverse-distribution displacements are carried out by movement of the primary drum.

44. The method of claim 42, wherein the circumferential-distribution rotary motion and the controlled relative transverse-distribution displacements are carried out by an actuating assembly engaging the primary drum.

45. The method of claim 34, wherein after transferring the belt structure to a position coaxially centered with respect to the carcass structure and before winding up the at least one strip element, the primary drum is moved towards at least one delivery member from a position in which the primary drum interacts with a transfer member shifting the belt structure onto the carcass structure.

46. The method of claim 40, further comprising:
moving the primary drum away from the at least one delivery member to a position near devices for disengaging the tyre from the primary drum.

47. The method of claim 34, further comprising:
transferring the primary drum to a region between at least one first delivery member for applying the tread band and at least one second delivery member for manufacturing the sidewalls.

48. The method of claim 34, wherein disposing the carcass structure, shaping the carcass structure, applying the tread band, and applying the pair of sidewalls are cyclically carried out following a controlled rate on at least two primary drums, and
wherein disposing the carcass structure on a first primary drum is carried out before completing assembly of a tyre on a second primary drum.

49. The method of claim 34, further comprising:
forming the carcass structure on a building drum; and
transferring the carcass structure from the building drum to the primary drum.

50. The method of claim 49, wherein transfer of the carcass structure from the building drum to the primary drum is carried out after engagement of the belt structure with the carcass structure.

51. The method of claim 49, wherein forming the carcass structure comprises:
associating auxiliary inserts for elastic support with the at least one carcass ply;
wherein each of the auxiliary inserts comprises:
a radially internal edge disposed close to one of the annular anchoring structures; and
a radially external edge disposed close to a side edge of the belt structure.

52. The method of claim 34, further comprising:
applying the belt structure to the carcass structure; and
pressing the belt structure against the carcass structure to obtain better adhesion of the belt structure against the carcass structure.

53. The method of claim 34, further comprising:
storing carcass structures in engagement with respective belt structures;
wherein the storing is carried out before at least one of applying the tread band and applying the pair of sidewalls.

54. An apparatus for assembling tyres for vehicle wheels, comprising:
at least one primary drum;
an auxiliary drum;
a transfer member;
at least one unit for applying a tread band onto a belt structure; and
at least one unit for applying a pair of sidewalls against opposite lateral walls of a carcass structure;
wherein the at least one primary drum is arranged to support the carcass structure,
wherein the carcass structure comprises at least one carcass ply in engagement with annular anchoring structures axially spaced apart from each other,
wherein the auxiliary drum is set to carry the belt structure,
wherein the transfer member moves the belt structure from the auxiliary drum to the carcass structure,
wherein at least one of the units for applying the tread band, at least one of the units for applying the pair of sidewalls, or at least one of the units for applying the tread band and at least one of the units for applying the pair of sidewalls comprises at least one delivery member, and
wherein the at least one delivery member lays down at least one continuous strip element of elastomer material in contiguous circumferential coils on the carcass structure.

55. The apparatus of claim 54, wherein the at least one delivery member comprises at least one extruder.

56. The apparatus of claim 54, further comprising:
at least one actuating assembly;
wherein the at least one actuating assembly is associated with the at least one delivery member,
wherein the at least one actuating assembly drives the at least one primary drum in rotation around a geometric axis of the at least one primary drum so that the at least one strip element is circumferentially distributed onto the carcass structure, onto the belt structure, or onto the carcass structure and onto the belt structure, and
wherein the at least one actuating assembly causes controlled relative transverse-distribution displacements between the at least one primary drum and the at least one delivery member for distributing the at least one strip element to form the circumferential coils disposed in mutual side-by-side relationship.

57. The apparatus of claim 56, wherein the at least one actuating assembly operates on the at least one primary drum to move the at least one primary drum relative to the at least one delivery member.

58. The apparatus of claim 57, wherein the at least one actuating assembly is integrated into a robotized arm engaging the at least one primary drum.

59. The apparatus of claim 57, wherein the at least one actuating assembly comprises:
a carriage movable along a guide structure between a first position and a second position;
wherein in the first position, the carriage supports the at least one primary drum near devices for disposing the carcass structure, and
wherein in the second position, the carriage supports the at least one primary drum near the at least one delivery member.

60. The apparatus of claim 56, further comprising:
devices for disposing the carcass structure on the at least one primary drum;
wherein the at least one actuating assembly is arranged to cause translation of the at least one primary drum towards the at least one delivery member, starting from a position in which the at least one primary drum interacts with the devices for disposing the carcass structure.

61. The apparatus of claim 54, further comprising:
at least one first delivery member designed to form the tread band; and
at least one second delivery member designed to form the pair of sidewalls.

62. The apparatus of claim 54, further comprising:
at least one first primary drum;
at least one second primary drum; and
at least two actuating assemblies;
wherein the at least one first primary drum is engaged by a first actuating assembly,
wherein the at least one second primary drum is engaged by a second actuating assembly, and
wherein the at least one first and second primary drums interact sequentially with devices for disposing the carcass structure, the at least one unit for applying the tread band, and the at least one unit for applying the pair of sidewalls.

63. The apparatus of claim 54, further comprising:
a building station for forming the carcass structure on a building drum; and
devices for transferring the carcass structure from the building drum to the at least one primary drum.

64. The apparatus of claim 63, wherein the devices for transferring the carcass structure comprise:
a storage magazine; and
an auxiliary transfer member;
wherein the auxiliary transfer member transfers the carcass structure from the building drum to the storage magazine.

65. The apparatus of claim 54, further comprising:
devices for associating auxiliary elastic-support inserts with the at least one carcass ply;
wherein each of the auxiliary inserts comprises:
a radially internal edge disposed close to one of the annular anchoring structures; and
a radially external edge disposed close to a side edge of the belt structure.

66. The apparatus of claim 54, wherein the transfer member moves the belt structure from the auxiliary drum to the carcass structure disposed on the at least one primary drum.
